(19) United States
(12) Patent Application Publication
(10) Pub. No.: US 2014/0319431 A1
(43) Pub. Date: Oct. 30, 2014

(54) ELECTRICALLY CONDUCTIVE PRINTABLE COMPOSITION

(71) Applicants: Daniel Rudhardt, Koln (DE); Frank Sicking, Overath (DE); Stefanie Eiden, Leverkusen (DE); Venkataramanan Balasubramaniam, Singapore (SG); Stefan Bahnmuller, Kuerten (DE); Rachel Tessy Mathew, Singapore (SG); Fransiska Cecilia Kartawidjaja, Singapore (SG)

(72) Inventors: Daniel Rudhardt, Koln (DE); Frank Sicking, Overath (DE); Stefanie Eiden, Leverkusen (DE); Venkataramanan Balasubramaniam, Singapore (SG); Stefan Bahnmuller, Kuerten (DE); Rachel Tessy Mathew, Singapore (SG); Fransiska Cecilia Kartawidjaja, Singapore (SG)

(73) Assignee: BAYER INTELLECTUAL PROPERTY GMBH, Monheim (DE)

(21) Appl. No.: 14/126,464

(22) PCT Filed: Jun. 13, 2012
(86) PCT No.: PCT/EP2012/061152

§ 371 Date: Jul. 15, 2014

(30) Foreign Application Priority Data
Jun. 17, 2011 (SG) 201104468-2

(51) Int. Cl. C09D 11/00

(52) U.S. Cl. CPC C09D 11/52
USPC 252/514

(57) ABSTRACT

An electrically conductive printable composition comprises silver particles, a dispersing agent, a solvent, a first surfactant, comprising a hydrocarbon based surfactant, and a second surfactant, comprising a fluoro-based surfactant.

### FIELD OF THE INVENTION

This invention relates to compositions suitable for use as ink, and more particularly to compositions suitable for use as electrically conductive ink.

### BACKGROUND OF THE INVENTION

Compositions for use as electrically conductive ink are valuable for creating circuits on the surface of non-conductive materials such as plastics, glass, some composites, etc. Such compositions typically comprise a solution of an electrically conductive material, such as gold, silver or copper in the form of particles in the solution, which can be applied through one of several known printing technologies. These printing technologies include focused aerosol beam technology, sometimes referred to as maskless mesoscale material deposition (M3D). M3D may also be used in large area printing.

Various silver conductive inks are known, and have enjoyed some success and printable compositions suitable for application to non-conductive substrates, especially polymers. However, some intermittent issues have arisen with such known silver compositions, including, for example, incomplete application to the substrate, the formation of pin hole defects, clogging of printing nozzles, difficulties with application to the substrate at startup of a process to apply the composition. It would therefore be desirable to provide an electrically conductive printable composition where such issues have been reduced.

### SUMMARY OF THE INVENTION

In accordance with a first aspect, an electrically conductive printable composition comprises silver particles, a dispersing agent, a solvent, a first surfactant, comprising a hydrocarbon based surfactant, and a second surfactant, comprising a fluoro-based surfactant.

From the foregoing disclosure and the following more detailed description of various embodiments it will be apparent to those skilled in the art that the present invention provides a significant advance in the technology of electrically conductive printable compositions. Particularly significant in this regard is the potential the invention affords for providing electrically conductive printable compositions with reduced defects and enhanced resistance to clogging of printing nozzles. Additional features and advantages of various embodiments will be better understood in view of the detailed description provided below.

### DETAILED DESCRIPTION OF CERTAIN EMBODIMENTS

It will be apparent to those skilled in the art, that is, to those who have knowledge or experience in this area of technology that many uses and design variations are possible for the electrically conductive printable compositions disclosed here. The following detailed discussion of various alternate features and embodiments will illustrate the general principles of the invention with reference to a printable composition suitable for use in printing portions of circuits onto substrates. Other embodiments suitable for other applications will be apparent to those skilled in the art given the benefit of this disclosure.

An electrically conductive printable composition is disclosed herein which comprises an electrically conductive metal such as silver particles in a dispersing agent, a solvent, a first surfactant comprising a hydrocarbon based surfactant, and a second surfactant comprising a fluoro-based surfactant. The composition can be applied to a substrate, including glass, plastics, and transparent conductive oxides, for example. The silver particles can be nanoparticles, each having a diameter of 10 to a maximum no greater than 150 nm, for example, preferably 20 to 80 nm, and more preferably 40 to 80 nm, such as 60 nm, for example, as measured using a Malvern zetasizer based on dynamic light scattering techniques. 10-60% by weight of the composition by may comprise these silver particles, more preferably 30-50 wt %.

The silver particles are mixed with the dispersing agent. The dispersing agent can comprise any of numerous compositions and mixtures suitable for carrying the silver particles, such as at least one of: alkoxylates, alkylolamides, esters, amine oxides, alkyl polyglucosides, alkylphenols, arylalkylphenols, water-soluble homopolymers, water-soluble random copolymers, water-soluble block copolymers, water-soluble graft polymers, polyvinyl alcohols, copolymers of polyvinyl alcohols and polyvinyl acetates, polyvinyl pyrrolidones, cellulose, starch, gelatine, gelatine derivatives, polymers of amino acids, polylysine, polyaspartic acid, polyacrylates, polyethylene sulfonates, polystyrene sulfonates, polymethacrylates, condensation products of aromatic sulfonic acids and formaldehyde, naphthalene sulfonates, lignin sulfonates, copolymers of acrylic monomers, polyethylenimines, polyvinylamines, polyallylamines, poly(2-vinylpyridines), block copolyethers, block copolyethers with polystyrene blocks and/or polydiallyldimethylammonium chloride. More particularly, polyvinylpyrrolidones with a molecular weight of about 8000 to 400,000 AMU (e.g. PVP K15 from Fluka) and polyvinylpyrrolidone with a molecular weight of about 360000 amu (e.g. PVP K90 from Fluka) can be used as the dispersing agent, or block copolyethers with polystyrene blocks with 62 wt % of C₂-polyether, 23 wt % of C₃-polyether and 15 wt % of polystyrene with respect to the dried dispersing agent, with a ratio of block lengths C₂-polyether to C₃-polyether of 7:2 units (such as Disperbyk 190 from BYK-Chemie, Wesel), for example. Such a dispersing agent helps to prevent flocculation of pigments and therefore stabilizes the hue and color strength of the printable composition. Flooding and floating are reduced, and storage stability of the printable composition is increased. Wetting and gloss are improved, and millbase viscosity is reduced.

The solvent can comprise one or more of C₁-C₅ alcohols, lactams, ureas, and cyclic ureas. In one embodiment, the solvent is a co-solvent comprising both 1,2 propanediol and 2-pyrrolidone. Other suitable solvents include, for example, ethylene glycol and 2-methyl-1,3-propanediol. The solvent may be present in the composition in an amount of 5-40% by weight of the composition.

An additional additive may be provided in the composition, and can be chosen from the set of: pigments, antifoam agents, light stabilisers, optical brighteners, corrosion inhibitors, antioxidants, algicides, plasticisers, thickeners, surface-active substances. Pluronic PE10400 (from BASF, Ludwigshafen), a water soluble triblock copolymer of C₃-polyether, C₂-polyether, C₃-polyether units having 40 wt. % of the C₂-polyether is most particularly preferably used as additive. Use of inorganic bases such as NaOH or KOH can make silver film nonconductive at pH of 8.0 and above. Therefore, optionally an organic base such as triethanol amine or N,N′-dimethyl ethanolamine may be used as a pH adjuster, to keep the pH of the composition at a level where the composition remains electrically conductive.

In accordance with a highly advantageous feature, a pair of surfactants are used in the composition. It has been found that the combination of surfactants helps significantly reduce incomplete application to the substrate, the formation of pin hole defects, clogging of printing nozzles, and difficulties with application to the substrate at startup. The first surfactant can be a hydrocarbon based surfactant, such as one or more of an ethoxylated decyn-diol, an alkyl diphenyloxide disulfonate, and a dioctyl sodium sulfosucccinate. Suitable first surfactants comprise. Surfynol 465, which contains ethoxylated 2, 4, 7, 9-tetramethyl 5 decyn-4,7-diol, as well as other related mixtures which also contain decyn-diols such as Surfynol 2502, Surfynol 485, and Surfynol TG, supplied by Air Products and Chemicals; Dowfax 8390 and Dowfax 2A1, supplied by The Dow Chemical Company, and other related mixtures containing alkyl diphenyloxide disulfonates; and Aerosol OT-75, supplied by Cytec Industries, Inc., and other mixtures containing dioctyl sodium sulfosucccinate. Generally, ethoxylated/propoxylated acetylenic-based materials can be used as the first surfactant.

The second surfactant is one or more of a fluoro-based surfactant such as a fluorinated polyoxetane or a fluoroaliphatic polymeric ester. Suitable mixtures containing fluorinated polyoxetanes, can comprise, for example, Polyfox 151N and Polyfox 154N, supplied by Omnova Solutions; and Novec FC 4430 and Novec FC 4432, supplied by the 3M Company, and other mixtures containing fluoroaliphatic polymeric esters. The first surfactant and the second surfactant combined may be present in the composition in an amount by weight of less than 1% of the composition, and more preferably less than 0.3% of the weight of the composition.

The remainder of the composition can comprise water. Water may be present in the composition in an amount of at least 30%, depending on the application. In addition to the aforementioned advantages, compositions created here can have higher percentage bulk conductivity than many known electrically conductive silver inks. This may be due in part to the ability to apply such compositions more uniformly and consistently. Electrically conductive printable compositions as described herein can advantageously be applied to a surface of a substrate such as glass or plastic or another material or combination of materials used as a circuit board.

### EXAMPLES

### Example 1

A composition comprising 16 wt % 1,2 propane diol, 12 wt % 2-pyrrolidone, 35 wt % of a Silver-dispersing agent solution of Ag Disperbyk 190, 0.12 wt % pluronic PE 10400, 0.5% hydrocarbon surfactant Surfynol 485, 0.12 wt % fluoro-based surfactant Novec FC 4432, and 36.32 wt % water were mixed together. The composition had a pH of 5.58. The composition was applied to a Dimatix Materials Printer DMP 2831 equipped with a 10 pl printhead. A suitable voltage was applied and the composition was applied to a glass or high temperature polycarbonate film. The composition and substrate were sintered at 220° C. for one hour in a vented oven. Resistance measurements were performed using a mutlimeter or a sheet resistivity and step height using surface profilometer. The percentage bulk conductivity of the composition on the substrate was 43%. Percentage bulk conductivity is the ratio of conductivity to a pure metal×100. Where the metal is silver, the unitless number is percentage bulk silver conductivity. The composition exhibited good optical characteristics, and is essentially free of pinhole defects as confirmed by scanning electron microscope (SEM) micrographs.

### Example 2

A composition comprising 16 wt % 1,2 propane diol, 12 wt % 2-pyrrolidone, 35 wt % of a silver/dispersing agent solution of Ag Disperbyk 190, 0.12 wt % pluronic PE 10400, 0.5 wt % hydrocarbon surfactant Surfynol 2502, 0.12 wt % fluoro-based surfactant Polyfox 151N, and 36.26 wt % water were mixed together. The composition had a pH of 5.6. The composition was applied to a substrate in the same manner as Example 1. The percentage bulk conductivity of the composition on the substrate was 36%. The composition exhibited good optical characteristics, essentially free of pinhole defects, as confirmed by SEM micrographs.

### Example 3

A composition comprising 16 wt % 1,2 propane diol, 12 wt % 2-pyrrolidone, 35 wt % of a silver/dispersing agent solution of Ag Disperbyk 190, 0.12 wt % pluronic PE 10400, 0.5 wt % hydrocarbon surfactant Surfynol 465, 0.06 wt % fluoro-based surfactant Novec FC 4432, and 36.32 wt % water were mixed together. The composition had a pH of 5.57. The composition was applied to a substrate in the same manner as Example 1. The percentage bulk conductivity of the composition on the substrate was 31%. The composition exhibited good optical characteristics, essentially free of pinhole defects, as confirmed by SEM micrographs.

### Example 4

A composition comprising 16 wt % 1,2 propane diol, 12 wt % 2-pyrrolidone, 35 wt % of a silver/dispersing agent solution of Ag and Disperbyk 190, 0.12 wt % pluronic PE 10400, 0.5 wt % hydrocarbon surfactant Surfynol TG, 0.06 wt % fluoro-based surfactant Novec FC 4432, and 36.32 wt % water were mixed together. The composition had a pH of 5.55. The composition was applied to a substrate in the same manner as Example 1. The percentage bulk conductivity of the composition on the substrate was 35%. The composition exhibited good optical characteristics, essentially free of pinhole defects, as confirmed by SEM micrographs.

### Example 5

A composition comprising 16 wt % 1,2 propane diol, 12 wt % 2-pyrrolidone, 35 wt % of a silver/dispersing agent solution of Ag and Disperbyk 190, 0.12 wt % pluronic PE 10400, 0.5 wt % hydrocarbon surfactant Surfynol 465, 0.12 wt % fluoro-based surfactant Polyfox 154N, and 36.26 wt % water were mixed together. The composition had a pH of 5.48. The composition was applied to a substrate in the same manner as Example 1. The percentage bulk conductivity of the composition on the substrate was 33%. The composition exhibited good optical characteristics, essentially free of pinhole defects, as confirmed by SEM micrographs.

### Example 6 (M3D Application)

A composition comprising 6 wt % 1,2 propane diol, 9 wt % 2-pyrrolidone, 45 wt % of a silver/dispersing agent solution of Ag and Disperbyk 190, 0.24 wt % hydrocarbon surfactant Surfynol 2502, 0.01 wt % fluoro-based surfactant Novec FC 4432, and 39.75 wt % water were mixed together. The composition had a pH of 5.74. The composition was applied to a substrate as a focused aerosol beam using M3D aerosol jet technology at 220° C. The percentage bulk conductivity of the composition on the substrate was 25.33%. The composition exhibited good optical characteristics, essentially free of pinhole defects, as confirmed by SEM micrographs.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An electrically conductive printable composition comprising, in combination:
silver particles;
a dispersing agent;
a solvent;
a first surfactant, comprising a hydrocarbon based surfactant; and
a second surfactant, comprising a fluoro-based surfactant.

2. The electrically conductive printable composition of claim 1 further comprising water.

3. The electrically conductive printable composition of claim 2 further comprising an additional additive, wherein the additional additive is a water soluble block copolymer.

4. The electrically conductive printable composition of claim 3 wherein the copolymer is a tri-block copolymer.

5. The electrically conductive printable composition of claim 1 further comprising a substrate, wherein the composition is applied to a surface of the substrate.

6. The electrically conductive printable composition of claim 1 wherein the dispersing agent is one or more of a polyvinylpyrrolidone, a block copolyether, and a block copolyether with polystyrene blocks.

7. The electrically conductive printable composition of claim 6 wherein the solvent is a co-solvent comprising 1,2 propanediol and a 2-pyrrolidone.

8. The electrically conductive printable composition of claim 6 wherein the solvent is one of ethylene glycol and 2-methyl-1,3-propanediol.

9. The electrically conductive printable composition of claim 7 wherein the silver particles are silver nanoparticles having a maximum diameter of 150 nm.

10. The electrically conductive printable composition of claim 7 wherein the silver particles are silver nanoparticles having a mean diameter of 40-80 nm.

11. The electrically conductive printable composition of claim 9 wherein the first surfactant is one or more of an ethoxylated decyn-diol, an alkyl diphenyloxide disulfonate, and a dioctyl sodium sulfosucccinate.

12. The electrically conductive printable composition of claim 11 wherein the second surfactant is one or more of a fluorinated polyoxetane and a fluoroaliphatic polymeric ester.

13. The electrically conductive printable composition of claim 1 wherein:
the first surfactant is one or more of Surfynol 2502, Surfynol 485, Surfynol TG, Surfynol 465, Dowfax 8390, Dowfax 2A1 and Aerosol OT-75; and
the second surfactant is one or more of Polyfox 151N, Polyfox 154N, Novec FC 4430 and Novec FC 4432.

14. The electrically conductive printable composition of claim 1 wherein
10-60 wt % by weight of the composition are the silver particles;
0.1 to 15 wt% by weight of the composition is the dispersing agent;
5-40 wt % by weight of the composition is the solvent; and
the first surfactant and the second surfactant combined are less than 1 wt % of the weight of the composition.

15. The electrically conductive printable composition of claim 14 wherein at least 30 wt % by weight of the composition is water.
